(19) United States
(12) Patent Application Publication
(10) Pub. No.: US 2007/0213001 A1
(43) Pub. Date: Sep. 13, 2007

(54) Window defroster system

(76) Inventors: Douglas J. Vander Berg, Sioux Center, IA (US); Jeff Vander Berg, Sioux Center, IA (US)

Correspondence Address: Brian J. Laurenzo;Dorsey & Whitney LLP, Suite 3900, 801 Grand Avenue, Des Moines, IA, 50309, US

(21) Appl. No.: 11/370,970

(22) Filed: Mar. 8, 2006

(51) Int. Cl. E06B 7/02; A47L 1/16

(52) U.S. Cl. 454/198; 454/196

(57) ABSTRACT

A window defroster system is provided. The window defroster system disclosed comprises an operable communication with an HVAC or forced air system of a building in which the device is located. The system comprises a first duct in communication with an air supply from a furnace, and a boot in an operable communication with the first duct. A second duct is in operable communication with the boot for directing air toward a window. A window boot is in operable communication with the second duct for transmitting air onto a window. A window defroster system comprising a manifold device as well as window defroster systems for use in connection with a control, such as in connection with a bathroom vent, are also disclosed herein.

### FIELD OF INVENTION

This invention relates to air distribution systems, and in particular to window defroster systems for windows of homes, buildings and the like.

### BACKGROUND

Condensation collection on exterior windows is widely know to be a concern in many buildings, both residential and commercial, particularly during the winter months when the contrast between cold air outdoors and warm, moist air indoors causes condensation, fogging and freezing on the window. Bathrooms are of particular concern, due to the exposure of the window to a high level of moisture from the various water sources in the bathroom, which ultimately leads to significant condensation and/or frosting or icing over of the window. Condensation reduces visibility through the window, may result in water damage to the frame of the window, as well as mold and mildew formation and in the winter, and results in icing over or freezing of the window.

Common forced air heating and cooling systems comprise a HVAC system that transmits air via supply and return systems throughout a home or building. These systems are sized to provide the correct air flow to meet room-by-room calculated heating and cooling loads. Often these systems include duct work, such as sealed supply ducts, that provide proper air flow. Likewise, a return system is generally installed, including ducts sized to provide the correct return flow of air to a furnace.

HVAC systems are generally attached to a furnace system. As is common, the furnace generates and supplies warmed or heated air. This air is transmitted or forced via, for example, a fan attached to or integral with the furnace, through the duct work into the various rooms. Likewise, a cooling system is typically attached in forced air furnace systems, such as an air conditioner unit or the like.

Ducts of furnace systems, or HVAC systems, are typically routed through joists, trusses, roofs, firewalls, house or building walls, both interior and exterior, and within the floor or ceiling of same. These ducts often include a register providing an opening into a room, and in many instances, comprise a grill that directs the air within the duct out into the room.

Various attempts have been made at systems to eliminate condensation on windows. However, no such system has been easily adaptable to existing HVAC or forced air systems, or easy to install in connection with new construction. Likewise, these systems have not provided an effective means of eliminating condensation or ice buildup on the window. In view of same, a need exists for a system of removing condensation, and for defrosting a window in a residential or commercial building, which is both easy to install and effective for the purposes intended.

### SUMMARY OF THE INVENTION

A window defroster system is provided in which air is provided from a air supply source. The air is transmitted from the supply source into a building air supply system. Air flow is then transmitted or split from the building air supply system and directed onto at least one window.

The disclosed window defroster system comprises a first duct operably connected to an air supply from a furnace. A boot is operably connected to the first duct. The boot comprises a boot register for transmitting air into a room. A second duct is operably connected to the boot for directing air toward a window. In operation, warm air is transmitted from the furnace, through the first duct, through the boot, through the second duct and out onto the window. A window boot is operably connected to the second duct for transmitting air onto the window.

A window defroster system comprising a manifold-device is also disclosed. Namely, the manifold type system comprises a manifold device having an air inlet portion preferably in communication with a furnace. At least one pipe is operably attached to the manifold device, and the pipe extends from the manifold device to a window. A window boot is operably connected, or attached to, the pipe for transmitting air onto a window. Thus, air flows from the furnace into the manifold device, from the manifold device into a pipe extending therefrom, through the pipe to a window boot, and is exhausted out of the window boot onto the window.

Also provided is a window defroster system comprising an inline blower in operable connection with a control switch and a means for transmitting air from the inline blower to a window. This system comprises, in addition to the inline blower and switch, a first duct operably connected to the inline blower, a boot operably connected to the first duct, a second duct operably connected to the boot, and a window boot operably connected to the second duct for transmitting air onto the window.

The warm air which is blown onto the window via the foregoing systems effectively eliminates condensation, or ice buildup on the window.

### BRIEF DESCRIPTION OF THE DRAWINGS

The invention will now be described, by way of example, with reference to the attached drawings, of which:

FIG. 1 is a side elevational view of the window defroster system of an embodiment of the present invention.

FIG. 2A is a cut away view of the boot of the embodiment shown in FIG. 1.

FIG. 2B is a cut away, end elevational view of the boot shown in FIG. 2A.

FIG. 3A is a cut away, side elevational view of the window defroster system of FIG. 1.

FIG. 3B is an end elevational view of an embodiment of the window boot of the present invention.

FIG. 3C is a side elevational view of the window boot of the embodiment shown in FIG. 3B.

FIG. 3D is a top plan view of the window boot of an embodiment of the window defroster system shown in FIG. 1.

FIG. 3E is a top plan view of an embodiment of the grill or register used in connection with the window defroster system of the present invention.

FIG. 4A is a cut away, side elevational view of an alternative embodiment of the window defroster system of the present invention for use with a concrete wall.

FIG. 4B is an end elevational view of the boot shown in FIG. 4A.

FIG. 5 is a side elevational view of the window defroster system of an alternative embodiment of the present invention in which a manifold device is used.

FIG. 6 is a side elevational view of the manifold device shown in FIG. 5.

FIG. 7 is an end elevational view of the manifold device shown in FIG. 5.

FIG. 8A is a side elevational view of the window boot shown in FIG. 5.

FIG. 8B is an end elevational view of the window boot shown in FIG. 5.

FIG. 8C is a top plan view of the window boot shown in FIG. 5.

FIG. 8D is a front elevational view of the window boot show in FIG. 5.

FIG. 8E is a top plan view of a grill or register used in an embodiment of the present invention.

FIG. 9 is a side elevational view of an embodiment of the window defroster system of the present invention comprising a use in connection with a bathroom.

FIG. 10 is a alternative embodiment of the window defroster system shown in FIG. 9 having a manifold device thereon.

### DETAILED DESCRIPTION OF PREFERRED EMBODIMENTS

A window defroster system is disclosed. The window defroster system of the preferred embodiment is easy to install and effective for removing condensation from a window or plurality of windows, or for defrosting a window or plurality of windows to which it is attached. The window defroster system may be used on or in connection with any window in a residential or commercial building and may be attached to the forced air furnace system of the building or operated as a separate device. Furthermore, the window defroster system may be attached to one or more windows.

Advantageously, the window defroster system of an embodiment of the present invention comprises an operable connection to, and is in communication with, the HVAC system or furnace system of the house or building in which the device is located. The window defroster system comprises a first duct operably connected to and in communication with an air supply from a furnace, and a boot operably connected and in communication with the first duct. The boot comprises a boot register for transmitting air into a room. A second duct is operably connected to, and in communication with the boot for directing air toward a window. A window boot is also operably connected and in communication with the second duct for transmitting air onto the window. The window defroster system may also comprise a window register on the window boot for directing air onto the window. A damper for controlling airflow onto the window or out of the boot register may also be provided.

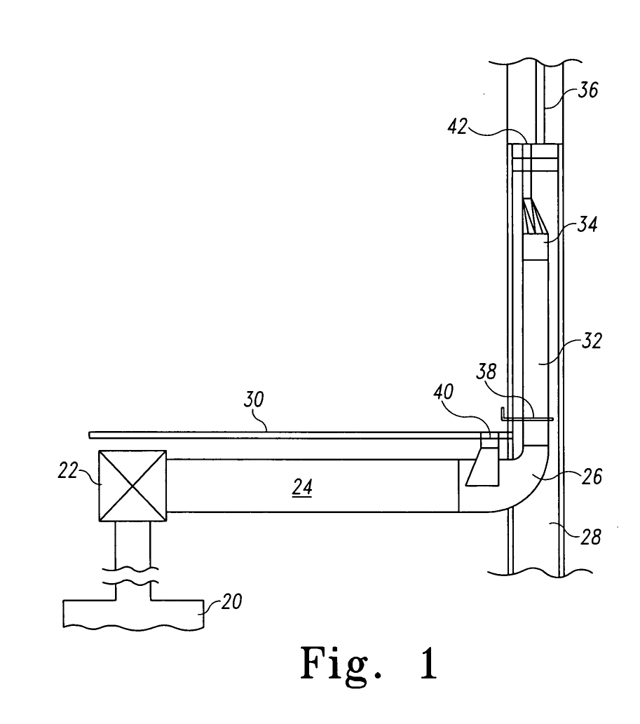

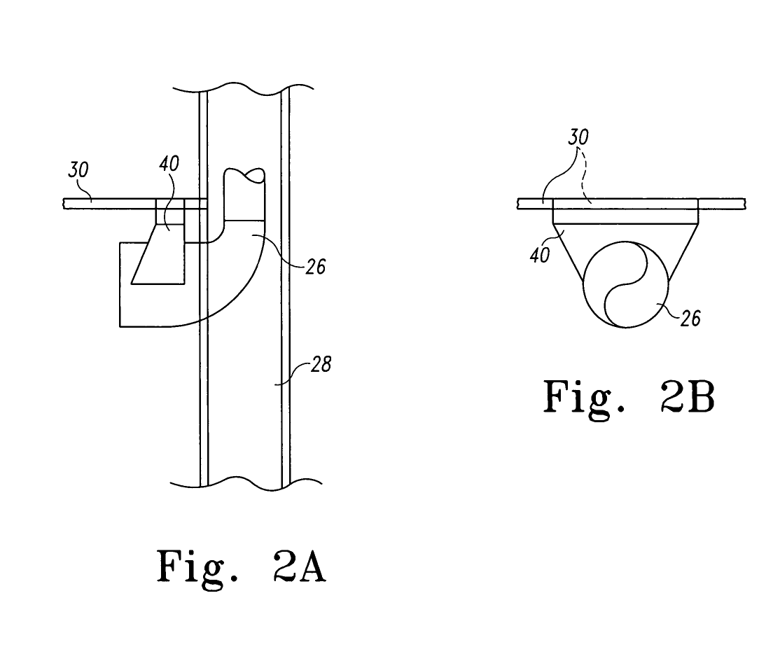

In further detail, as shown in FIG. 1, a first duct 24 of the window defroster system is interconnected to the forced air, or hot air, duct 22 of the building. This hot air duct 22 is attached to and in communication with the furnace system 20 of the building. As a result, hot or warm air is transmitted through same when the furnace 20 is activated. The first duct 24 extends from the forced air duct 22 toward an exterior wall 28 of the house or building within which the window 36 is positioned. The first duct 24 may be positioned below (or within) the floor 30 or above (or within) the ceiling. At the end of the first duct 24, at or near the exterior wall 28, a boot 26 is provided in operable communication to direct the flow of air from the first duct 24 toward a window 36. Extending from a portion of the boot 26, and in communication therewith, is a boot register 40. (See FIGS. 2A & 2B) The boot register 40 directs airflow from the first duct 24 and boot 26 into a room, similar to common forced air vents or registers used to transmit air into a room. The boot register 40 may be provided with a damper, a grill 42 or like component to control and/or direct airflow out of the register.

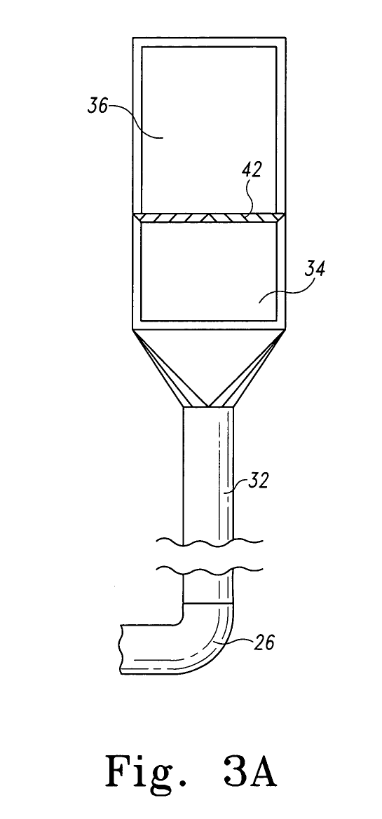

Referring to FIG. 3A, at the end of the boot 26, a second duct 32 extends toward the window 36. In a stud wall, the second duct 32 is preferably positioned within the wall 28, and more preferably, between the studs thereof (FIG. 1). A damper 38 is positioned along a portion of the second duct 32 or in the boot 26 to control airflow to the boot register 40 and to the window register 42 positioned on or near the window frame (discussed in further detail below). The damper 38 preferably comprises a manually operable device that is capable of being moved to restrict or permit airflow through the duct or boot 26. Preferably, a duct, such as a flex duct or oval duct, may be used to extend through the extension jamb of the window 36.

As shown in FIGS. 3A-3D, at the top of the second duct 32 a window boot 34 is provided which widens the airflow path to correspond with the width of the window frame, but narrows the passageway for air, thereby increasing the strength or velocity of airflow and forcing air onto the window 36. (See FIGS. 3B & 3C) Preferably, the window boot 34 comprises a narrowed diameter duct which widens at its top surface. A grill 42 is also preferably positioned and attached to the window boot 34 to direct airflow onto the window 36. The grill 42 comprises slats which are positioned to diffuse air to the corners of the window 36 and onto the window pane (See FIG. 3E). Preferably, the slats are positioned at an angle. Above the window boot 34 and/or grill 42 is the window pane of the window 36.

As can be seen in FIG. 1, the window defroster system of the preferred embodiment comprises a first duct 24 which has a diameter larger than the second duct 32. More preferably, the first duct 24 comprises a diameter that is twice the size of the second duct 32, such as a 6-inch round first duct 24 and a 3-inch round second duct 32. Furthermore, as can be seen the boot 26 matingly receives the first duct 24 at one end and narrows to matingly receive the second duct 32 at a second end. By providing a smaller second duct 32, the passageway for air is restricted. As a result, the velocity of air increases, providing airflow onto the window 36 with greater force. Advantageously, reducing duct size may, in certain instances, eliminate the need for additional fans and/or blowers to maintain or increase the velocity of airflow and effectively reduces condensation on the window 36. Although blowers and fans may be added without departing from the overall scope of the present invention.

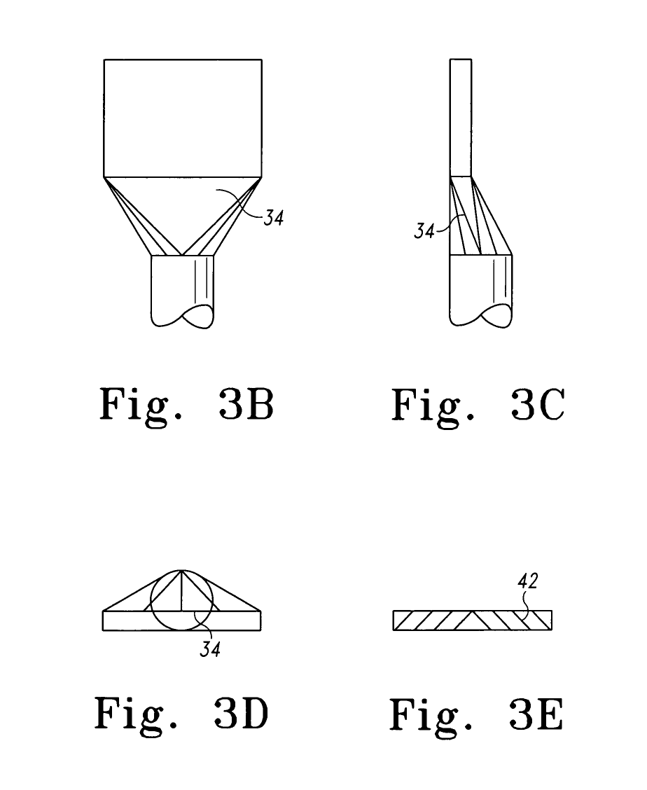

In addition to the above system, which is acceptable for use in a stud wall of a building and the like, as can be seen in FIG. 4A, the present invention is also adaptable for use in connection with a concrete wall 44, such as a basement wall, a sub-wall or commercial building wall and the like. Similar to the above-described system, the first duct 24 comprises a diameter that is larger than the diameter of the second duct 32. Preferably, for example, in a 6-inch subwall system, the first duct 24 comprises an approximately 6-inch round duct positioned below the floor 30. The second duct 32 may comprise, for example, a 3-inch round duct. Likewise, at an end of the first duct 24, a boot 26 is matingly received and has a boot register 40 for transmitting air into the room (See FIGS. 4A & 4B). The first duct 24 is operably attached to, and in communication with the HVAC or furnace system 20 as described with respect to the foregoing embodiment. However, as shown in FIG. 4A the boot 26 comprises a wider portion, such as in the example provided, a 6-inch round duct-contact portion, a narrowing duct portion, and a small duct portion, such as a 3-inch round duct portion. The small duct portion contacts and/or extends into the wall 44. In this manner, the boot 26 is narrowed to force air through the duct with greater velocity prior to the contact with the wall 44. The boot 26 extends into the concrete wall 44 and curves to an offset window boot 34 which diffuses air onto the window 36 as described hereinabove.

Specific examples, dimensions, and description is provided herein with respect to the ducts and various components of the window defroster system. However, one skilled in the art would understand that the window defroster system is not limited thereto and that other components, dimensions and devices may be used to accomplish the purposes provided.

As described herein, the present window defroster system of the embodiments described splits the air that is sent to floor or ceiling diffusers or registers from the furnace system 20 of the building by sending a portion of that air out of the boot 26, which is located in the floor 30 or ceiling, to the window 36. Air flows through the easiest available passage. Thus, by closing an initial diffuser or register, such as a boot register 40, air will be forced toward a second diffuser or register, such as the window diffuser or register 42. In the window defroster system, airflow is sent directly to the window pane by going through the window's extension jamb, and is controllable via a damper 38 in addition to or in combination with the initial diffuser or register 40. Further, by allowing airflow through a floor or ceiling diffuser 40 also attached to the boot 26, the system permits airflow into the room. The more the floor or ceiling diffuser 40 is closed, the more air will be released through the window diffuser 42.

In use, the floor or ceiling diffuser 40 is preferably open during the air conditioning season, providing a minimal amount of airflow onto the window 36. However, as the weather gets colder and moisture begins to form on the windows, blowing warm air on the glass or window pane will cause the window pane to be warmed and result in the elimination of moisture, condensation and/or frost.

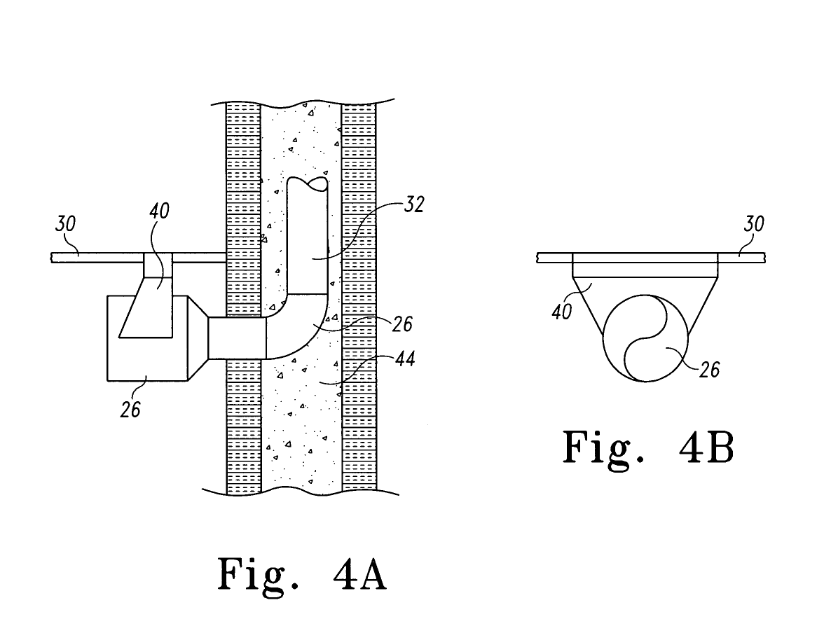

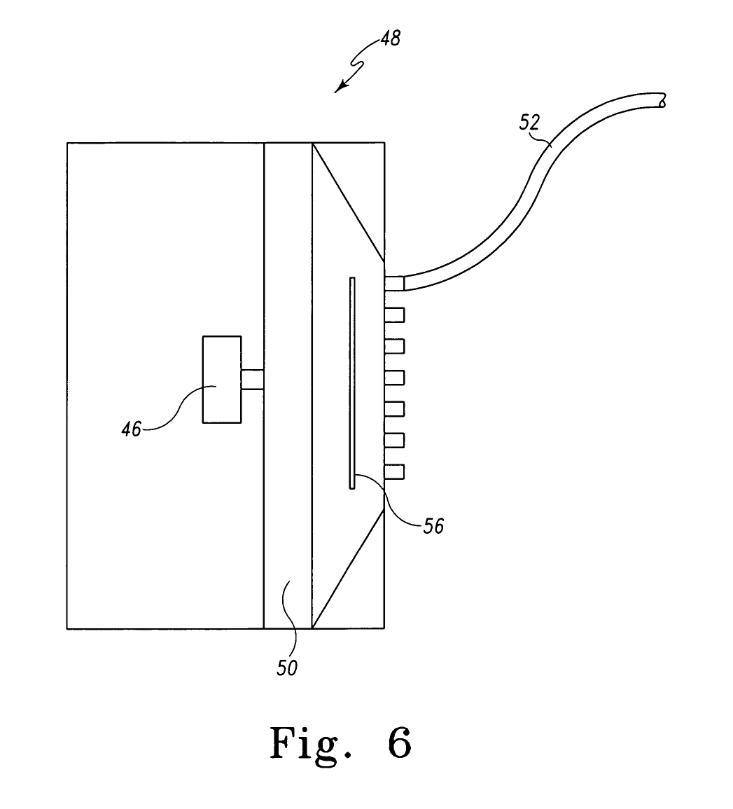

In an alternative embodiment, shown in FIGS. 5-8E, the window defroster system of the present invention comprises a manifold-type system. The manifold system utilizes small plastic pipes 52 in communication with a manifold device 48 which, in combination, transmits air through the system under high pressure. By running smaller pipes 52 from the manifold 48 under higher pressure, airflow is maintained to all relevant windows 36.

In a preferred embodiment, the manifold device 48 contains a compressor 50. Air is transmitted from the furnace 20 or other air supply source into the manifold device 48 where the air is compressed. Compressed air is then distributed to each window 36 through the small plastic pipes 52 which, preferably, range in size from ½ inch to 2 inches in diameter. In this embodiment, air from the furnace 20, or HVAC or other air supply source, is directed into the manifold device 48. Air is subsequently directed from the manifold device 48 into one or more individual pipes 52 extending out of the manifold device 48. The pipes 52 extend to, and are in communication with a window 36 or a plurality of windows. One or more pipes 52 may be connected to a single window 36. For example, large windows may require more than one pipe 52 directing air onto same, such as a pipe 52 positioned and directing air to each side of a window 36. Comparably, a small window 36 may require a single pipe 52. Alternatively, a window subject to higher humidity or moisture, such as a bathroom window, may require more than one pipe 52. Therefore, in a building with multiple windows, a plurality of pipes and combinations of pipes may be used to eliminate condensation on the window(s).

Again, specific examples, dimensions, and description is provided herein with respect to the ducts and various components of the window defroster system. However, one skilled in the art would understand that the window defroster system is not limited thereto and that other components, dimensions and devices may be used to accomplish the purposes provided.

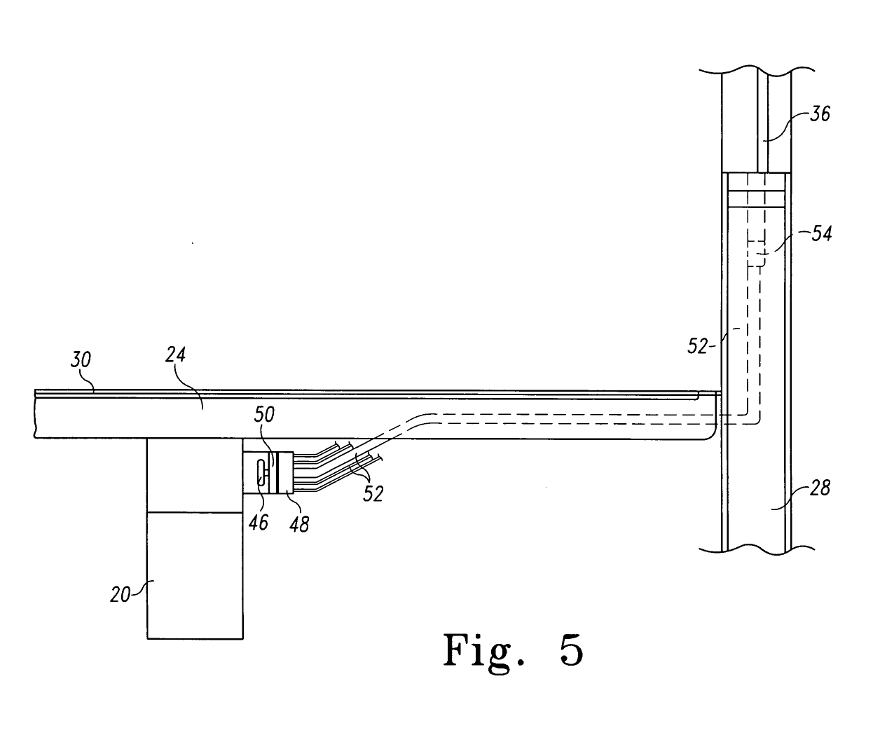

As indicated, and shown in FIGS. 5 & 6, the manifold device 48 preferably comprises a compressor 50 therein to increase airflow received from the furnace 20 or air supply source, forcing air into the pipe 52 or pipes extending from the manifold device 48 toward the window 36 or windows. A heat source 46 may also provided in the manifold device 48 to assist in warming the air flowing through same. Optionally, an additional electric heater 56 may further be added to the manifold system in order to provide heat or additional heat to the air transmitted through the manifold device 48. Preferably, one or more small pipes 52 are used in the manifold system (See FIGS. 6 & 7). Small diameter pipes increase airflow velocity as air is forced into a smaller area from a larger opening. Preferably, pipe size will vary with the length of the pipe 52 and the size of the window 36, so as to generate the appropriate level of airflow pressure in the system, thereby permitting the air to reach the window and effectively reduce condensation or defrost same. For instance, it is contemplated that the smallest diameter pipe 52 could be used for the window(s) furthest away from the manifold device 48. If necessary, additional inline blowers and/or compressors may be used to increase air velocity within the pipes 52 as needed.

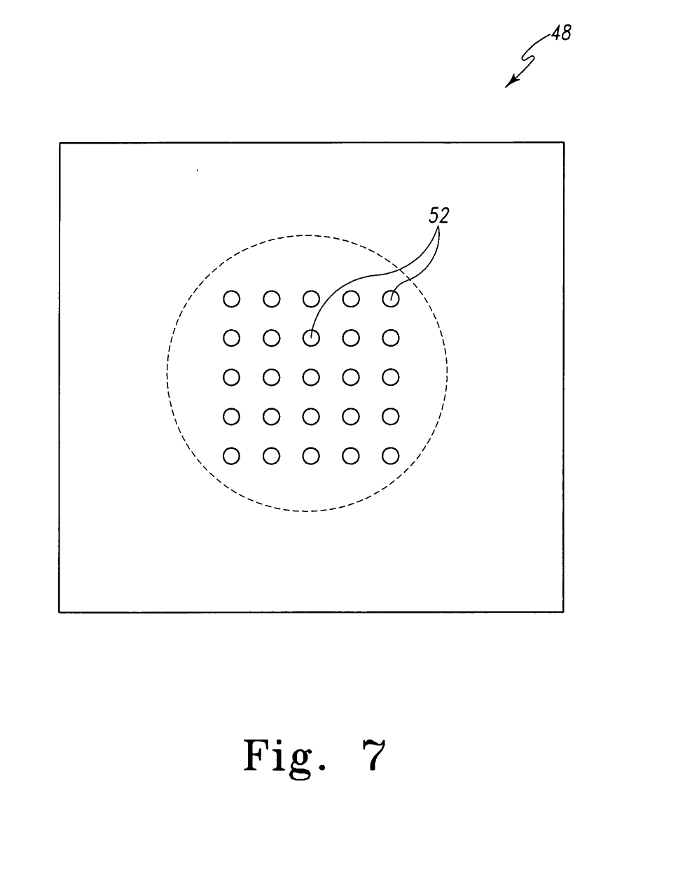

As shown in FIG. 5, the pipes 52 extend from the manifold device 48 to the exterior wall 28 of the building, and subsequently toward the window extension jamb of the window 36. The pipes 52 may have a window boot 54 attached thereto (FIGS. 8A & 8D) and are positioned below the window 36 and preferably offset from the window 36. An air diffuser or grill 42 is provided in operable communication with the pipe 52 and/or window boot 54 and is preferably attached to the window extension jamb to transmit air onto the window 36 similar to the grill 42 described hereinabove (See FIG. 8E).

As shown in FIGS. 8A-8D, the window boot 54, or offset boot, comprises a diameter opening corresponding to the size of the attached pipe 52 at the end connected to the attached pipe 52, and subsequently extends to a greater width, flattened-opening, to transmit air across a larger portion of the window 36.

The manifold-type system may be attached directly to the furnace 20 or near a portion thereof. In this system, warm air is obtained from the furnace 20 and transmitted to the windows of the building, via attached pipes 52. When the furnace 20 is in communication with the manifold device 48, the heat source 46 and/or electric heater 56 may or may not be used. Alternatively, the manifold system may exist separate from the furnace, in which case air is drawn from outside of the manifold device 48 and passes over the heat source 46 and/or electric heater 56 providing a source of warm air for defrosting.

Similar to the above-referenced systems, air travels within the pipes 52 below the floor 30 or within the ceiling and walls 28, and is then directed to the window boot 54, at which point the air is transmitted into a window diffuser 42 and subsequently onto a window 36. The pipes 52 of the manifold system may be positioned within the HVAC or forced air ducts 22 or 24 of the heating system (see FIG. 5) or may be separate therefrom.

The window defroster system is also adaptable for use in connection with bathroom vent systems. As is known, bathrooms are extremely susceptible to condensation, frosting, and mold on or around the windows and window frames due to the moisture created by, for example, the bath, shower, sink, and toilet. This is especially true in the winter months, when the contrast between, for instance, a hot shower and a cold window pane results in moisture or condensation forming on the window.

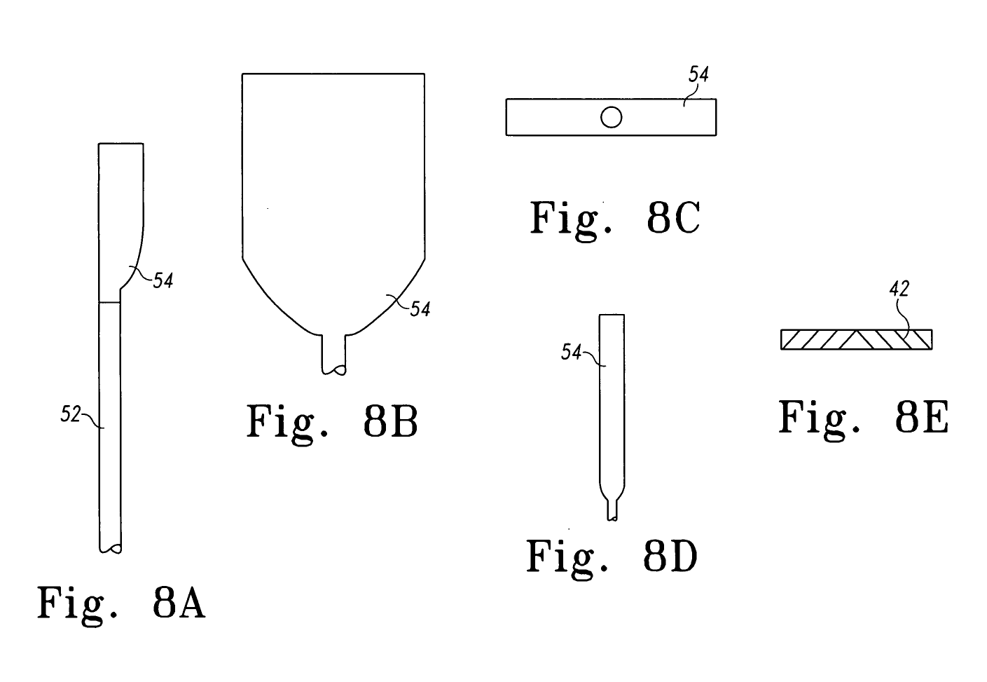

To alleviate this problem, an embodiment of the window defroster system comprises a defrosting means for use in connection with a bathroom window 36 are preferably tied to a control 70, similar to the bathroom vent, which is typically controlled by a localized switch or timer. Specifically, as shown in FIGS. 9 & 10, in a preferred embodiment, a blower, such as an inline blower 62 or 78, is used or engaged to direct and force air onto the bathroom window 36 simultaneously with activation of the bathroom vent or exhaust fan. This is controlled by a switch 70 in the bathroom. In other words, when the user activates the bathroom exhaust vent, usually via a switch, a timer, or the like, the bathroom window defroster is simultaneously engaged to direct air, preferably warm air, onto the window pane 36. If necessary, this bathroom defroster system may comprise a heat source 72, 80 to warm the air blown onto the bathroom window. The bathroom window defroster may also be operably connected and in communication with the furnace 20 or forced-air system of the building as shown in FIG. 9.

As indicated, a control 70 is used to activate or engage the bathroom window 36 defroster. The system may comprise a timer to keep the vent and/or blower 62 running for a period of time. Alternatively, a switch may be used. The timer and/or switch 70 controlling the defroster system may operate and be engaged by the bathroom exhaust vent switch, or may comprise a separate control, timer, switch or the like for activation of the defroster system. Furthermore, this system may be used alone, or in combination with the other window defroster systems disclosed herein. Likewise, these systems may be installed in existing buildings or in new construction.

Referring to FIG. 9, in further detail, the bathroom window defroster system comprises a furnace duct 58 connected to and in communication with the furnace system 20 of the building in which the bathroom window defroster system is placed. An inline blower 62 is integrally attached along a portion of this first duct 58, and in communication therewith. Preferably, the inline blower 62 is attached via a ducting arrangement 60, such as an additional duct, that diverts air from the furnace duct 58 into the inline blower 62 and then returns the airflow to the furnace duct 58. The inline blower 62 may be connected in a basement or elsewhere in the building. The inline blower 62 is controlled by a switch 70, such as a timer, a control, a bathroom exhaust fan switch and the like. The inline blower 62 may also operate in conjunction with the furnace 20. For example, in one embodiment, when the furnace fan is running, the inline blower 62 is not engaged. However, when the furnace 20 is not running, the inline blower 62 is activated or is controlled by the timer, switch or exhaust fan switch.

Optionally, as indicated above, the inline blower 62 may include a heat source 72. The optional heater or heat source 72 warms the air flowing through the inline blower 62, and may be controlled via a duct thermostat 74, or a thermostat 76 in the bathroom, to maintain the temperature of the air flowing onto the window 36.

A damper 68 may also be provided in connection with the inline blower 62 along a portion of the furnace duct 58 to prevent air from recirculating through the inline blower 62. The damper 68 is controlled in conjunction with the furnace 20 and the inline blower 62. Specifically, when the furnace fan is running, the damper 68 remains open. However, when the furnace fan is not running, the damper 68 remains closed so that air in the duct 58 is directed or drawn into the inline blower 62.

Similar to the above-described systems, air preferably flows through the furnace duct 58 below the bathroom floor 30 or in the ceiling until it reaches a boot 26 that directs the air 64 into a second duct 66 extending within the wall 28 toward the window 36. A single system or plurality of systems may be used to direct air onto one or a plurality of windows. At the end of that duct 66, a window boot 34 is provided through the extension jamb of the window 36 which allows air to be diffused onto the window 36. The window boot 34 is comparable to those previously disclosed herein and may further comprise a grill 42, register or the like for directing or controlling airflow.

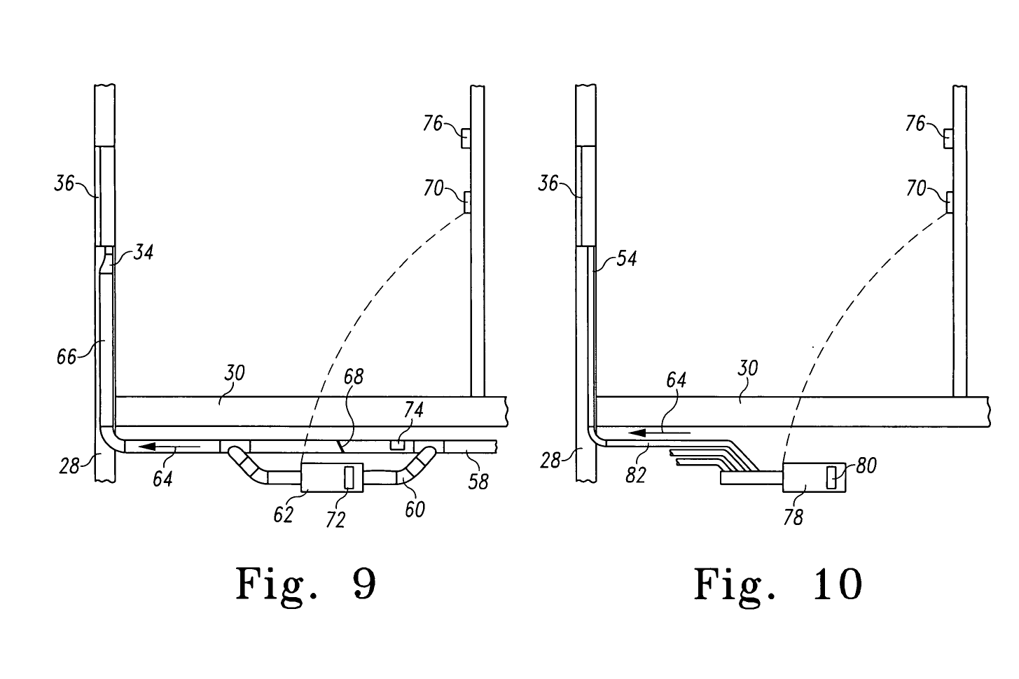

Turning to FIG. 10, the bathroom window defroster system may, alternatively, comprise a flexible duct or pipe 82 arrangement connected to a manifold device 48. In such a system, the inline blower 78 may be provided and may include an optional heat source 80. Likewise, a thermostat 76 may be provided to monitor and/or control air temperature. Similar to the above system, the inline blower 78 is controlled by a timer, a switch, or via the bathroom exhaust fan switch and the like 70. The inline blower 78 in the manifold system transmits air into a manifold device 48, which includes a number of narrow, flexible ducts or pipes 82 extending therefrom, and routes that air to one or more windows 36 within the building, preferably, the relevant bathroom windows 36.

Preferably, air is drawn into the blower 78, from the furnace 20 or other air supply source, and flows from the inline blower 78 into the manifold device. Air is then transmitted 64, via the flexible pipes 82, onto the relevant bathroom windows 36. As with the above-described manifold system, a window boot 54 may be installed to assist in directing airflow onto the window 36. Thus, in the case of a bathroom vent, the duct or pipe manifold system directs air through a duct below the bathroom floor 30 or within the ceiling and within the exterior wall 28 to the bathroom window 36 upon which the air is vented. This inline blower 78 may be installed in the basement of the building in which it is located, below or above the bathroom, or elsewhere within the building.

Accordingly, a window defroster system is disclosed. The window defroster comprises a device that preferably uses the standard house or building HVAC system, or forced air system, and splits the flow of air from same, directing that air onto one or more windows. Uniquely, a boot is used to draw air up into a duct toward the window in a manner that directs the air from the residential or commercial building furnace system onto the window.

The various mechanisms for the window defroster system and sub-assemblies thereof disclosed herein may be combined in numerous combinations, and the device and system should not be limited to the particular combinations described and illustrated herein.

Presently preferred embodiments of the present window defroster system and many of its improvements have been described with a degree of particularity. The previous description is of preferred examples for implementing same, and the scope of the invention should not necessarily be limited by this description.

We claim:

1. A window defroster system comprising:
a first duct in operable communication with an air supply from a furnace;
a boot in operable communication with the first duct, the boot comprising a boot register for selectively transmitting air into a room;
a second duct in operable communication with the boot for directing air toward a window; and
a window boot in operable communication with the second duct for transmitting air onto the window.

2. The window defroster system of claim 1, wherein the window boot further comprises a window register for selectively directing air onto the window.

3. The window defroster system of claim 1, further comprising a damper for selectively controlling airflow onto the window and out of the boot register.

4. The window defroster system of claim 1, wherein the second duct comprises a diameter narrower than the first duct.

5. The window defroster system of claim 1, further comprising an inline blower.

6. The window defroster system of claim 1, further comprising a heat source.

7. The window defroster system of claim 1, wherein the boot comprises a first portion connected to a narrowing portion, the narrowing portion being connected to a second portion having a diameter smaller than the first portion.

8. The window defroster system of claim 1, wherein the window boot comprises a duct connection portion and an air diffusing portion which air diffusing portion comprises a width greater than the duct connection portion, but narrower in diameter than the duct connection portion, thereby capable of causing an increase in airflow velocity.

9. A window defroster system comprising:
a manifold device having an air inlet portion in operable communication with an air supply source;
at least one small diameter pipe in operable communication with the manifold device, the pipe extending from the manifold device to a window;
a window boot in operable communication with the pipe and the window for transmitting air from the pipe onto the window.

10. The window defroster system of claim 9, further comprising a plurality of small diameter pipes in operable communication with the manifold device and extending to a plurality of windows.

11. The window defroster system of claim 9, further comprising a plurality of small diameter pipes in operable communication with the manifold device and extending to a single window.

12. The window defroster system of claim 9, wherein the manifold device comprises a compressor.

13. The window defroster system of claim 9, wherein the manifold device comprises a heat source.

14. The window defroster system of claim 9, wherein the manifold device comprises a plurality of heat sources.

15. The window defroster system of claim 9, wherein the pipe comprises a flexible pipe.

16. The window defroster system of claim 9, further comprising a window register in operable communication with the window boot.

17. The window defroster system of claim 5, wherein at least a portion of the pipe extends within a duct of a forced air system.

18. A window defroster system comprising:
a first duct in operable communication with an air supply from a furnace;
a boot in operable communication with the first duct;
a second duct in operable communication with the boot for directing air toward a window;
a window boot in operable communication with the second duct for transmitting air onto the window;
a third duct having an inline blower and in operable communication with the first duct; and
a control in communication with the inline blower for selectively engaging the inline blower to force air onto the window.

19. The window defroster system of claim 18, wherein the inline blower further comprises a heat source.

20. The window defroster system of claim 18, further comprising a damper for controlling airflow through the first duct, the third duct and inline blower in connection with the operation of the furnace.

21. The window defroster system of claim 18, further comprising at least one thermometer.

22. A window defroster system comprising:
a manifold device having an air inlet portion in operable communication with an air supply source;
at least one small diameter pipe in operable communication with the manifold device and extending from the manifold device to a window;
a window boot in operable communication with the pipe for transmitting air onto a window;
an inline blower in operable communication with the manifold device; and
a control in communication with the inline blower for selectively engaging the inline blower to force air through the manifold device and onto a window.

23. The window defroster system of claim 22, further comprising a heat source.

24. The window defroster system of claim 22, wherein a plurality of pipes extend from the manifold device to the window.

25. The window defroster system of claim 22, wherein a plurality of pipes extend from the manifold device to a plurality of windows.

26. The window defroster system of claim 22, further comprising a thermometer.

27. The window defroster system of claim 22, further comprising a window boot and window register for directing air onto the window.
